(19) United States
(12) Patent Application Publication
(10) Pub. No.: US 2024/0217799 A1
(43) Pub. Date: Jul. 4, 2024

(54) PRE-MIXING AND BATCHING SYSTEM

(71) Applicant: NIAGARA BOTTLING, LLC, Diamond Bar, CA (US)

(72) Inventors: Abhishek Shukla, Chino Hills, CA (US); Steven Kuo-Chuan Chen, Fountain Valley, CA (US)

(21) Appl. No.: 18/403,341

(22) Filed: Jan. 3, 2024

Related U.S. Application Data
(60) Provisional application No. 63/478,327, filed on Jan. 3, 2023.

(51) Int. Cl. B67C 3/00; B65G 47/19; B65G 65/32; B65G 53/14

(52) U.S. Cl. CPC B67C 3/007; B65G 47/19; B65G 65/32; B65G 53/14

(57) ABSTRACT

An ingredient preparation and batching system may include a first hydrated ingredient pre-mix station including a first holding tank configured to store a first hydrated ingredient consisting of water and one or more non-time constrained ingredients. The ingredient preparation and batching system may include a dry ingredient pre-mix station including a first hopper configured to store a first ingredient in dry form, a second hopper configured to store a second ingredient in dry form, and a mixer fluidly coupled to the first hopper and the second hopper. The mixer is configured to receive and mix the first ingredient and the second ingredient to form an ingredient mix. The ingredient preparation and batching system may include a batch tank fluidly coupled to the first holding tank and the mixer.

### CROSS-REFERENCE TO RELATED APPLICATIONS

This application claims priority to U.S. Provisional Patent Application No. 63/478,327, filed Jan. 3, 2023, the entire content of which is hereby incorporated by reference.

### FIELD

The present disclosure relates to the bottling of liquid products, and more particularly to the preparation of ingredients prior to bottling of the liquid products.

### BACKGROUND

Ingredients for the bottling of liquid products are typically manually combined prior to introduction into a bottling line. The ingredients are manually combined to create a batch that can be tested for quality and tracked by the bottler to ensure the proper combination of ingredients. The manual batching process is subject to operator error and can be inefficient. The manual batching process can also fail to meet the demand of a bottling line which fills bottles with the liquid product of the batch. In some instances, at least some of the ingredients are subject to time constraints according to which they must be bottled to meet relevant food safety regulations. A faster batching technique (e.g., ingredient combination technique) is therefore needed to maintain pace with the bottling line, avoid pauses in production, and ensure the liquid products are batched and bottled within the designated time constraints.

### SUMMARY

The present disclosure provides, in one aspect, an ingredient preparation and batching system for use with a bottling line. The ingredient preparation and batching system includes a first hydrated ingredient pre-mix station including a first holding tank configured to store a first hydrated ingredient consisting of water and one or more non-time constrained ingredients. The ingredient preparation and batching system also includes a dry ingredient pre-mix station including a first hopper configured to store a first ingredient in dry form, a second hopper configured to store a second ingredient in dry form, and a mixer fluidly coupled to the first hopper and the second hopper. The mixer is configured to receive and mix the first ingredient and the second ingredient to form an ingredient mix. The ingredient preparation and batching system also includes a batch tank fluidly coupled to the first holding tank and the mixer, the batch tank configured to receive a predetermined quantity of the first hydrated ingredient from the first holding tank, receive a predetermined quantity of the ingredient mix from the mixer, and store a batch of a liquid product including the first hydrated ingredient and the ingredient mix. The first ingredient is a time constrained ingredient.

The present disclosure provides, in another aspect, a dry ingredient pre-mix station for use with an ingredient preparation and batching system operable to supply a batch of a liquid product from a batch tank to a bottling line The dry ingredient pre-mix station includes a first hopper configured to store a first ingredient in dry form. The dry ingredient pre-mix station also includes a first unloader operably coupled to the first hopper and configured to receive a first package containing the first ingredient and unload the first time constrained ingredient from the first package into the hopper. The dry ingredient pre-mix station also includes a second hopper configured to store a second ingredient in dry form. The dry ingredient pre-mix station also includes a mixer fluidly coupled to the first hopper and the second hopper the mixer configured to receive and mix the first ingredient and the second ingredient to form an ingredient mix. The first ingredient is a time constrained ingredient.

The present disclosure provides, in another aspect, a method of preparing a batch of a liquid product for a bottling line. The method includes conveying a first ingredient in dry form from a first hopper to a mixer; conveying a second ingredient in dry form from a second hopper to a mixer; mixing the first ingredient and the second ingredient to form an ingredient mix; conveying the ingredient mix from the mixer to a batch tank; and combining the ingredient mix with a hydrated ingredient within the batch tank to produce a batch. The first ingredient is a time constrained ingredient.

Other features and aspects of the disclosure will become apparent by consideration of the following detailed description and accompanying drawings.

### BRIEF DESCRIPTION OF THE DRAWINGS

FIG. 1 is a schematic illustrating an ingredient preparation and batching system according to one embodiment of the present disclosure.

FIG. 2 is a schematic illustrating an ingredient preparation and batching system according to another embodiment of the present disclosure.

FIG. 3 is a schematic illustrating an ingredient preparation and batching system according to yet another embodiment of the present disclosure.

FIG. 4 is a schematic illustrating an ingredient preparation and batching system according to another embodiment of the present disclosure.

FIG. 5 is a schematic illustrating a dry ingredient preparation portion of the system of FIG. 4.

FIGS. 6A-6C schematically illustrate an ingredient preparation and batching system according to another embodiment of the present disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

Liquid products, such as isotonic, high-acid beverages, are dispensed into individual bottles by a bottling line which pulls pre-mixed ingredients from a batch tank to fill the bottles. Prior to the filling process, a manual batching process is used to pre-mix the ingredients based on a supplied recipe. The pre-mixed ingredients (i.e., the batch) are stored in the batch tank until bottling. The manual batching process involves at least one operator combining multiple ingredients based on the recipe. The ingredients must be manually weighed and mixed into the batch to allow for testing and to ensure the quality and safety of the end product.

In some instances, the bottling lines used to bottle the batch of ingredients can utilize an aseptic line which operates at a high rate of speed. For example, the bottling line may be capable of filling around 66,000 bottles per hour. When such a high speed bottling line is used, it is possible for the bottling line to deplete the batch of pre-mixed ingredients before the operators can prepare a new batch. Much of the time required to prepare the new batch is spent measuring (e.g., weighing) the ingredients to be included. The present disclosure improves the batching process by preparing some ingredients in bulk and supplying the ingredients quickly and accurately to the batch tank.

Recipes for liquid products to be bottled include major and minor ingredients. Major ingredients are common to a number of different recipes (e.g., citric acid or sugar (e.g., sucrose, dextrose, etc.)). Minor ingredients are specific to a certain recipe (e.g., coloring). Recipes typically have greater quantities of major ingredients than minor ingredients. The terms major and minor refer only to the above-described categories of ingredients and not to the importance of any individual ingredient in a recipe. The present disclosure provides a system for decoupling the preparation of major ingredients and minor ingredients to more efficiently prepare a batch.

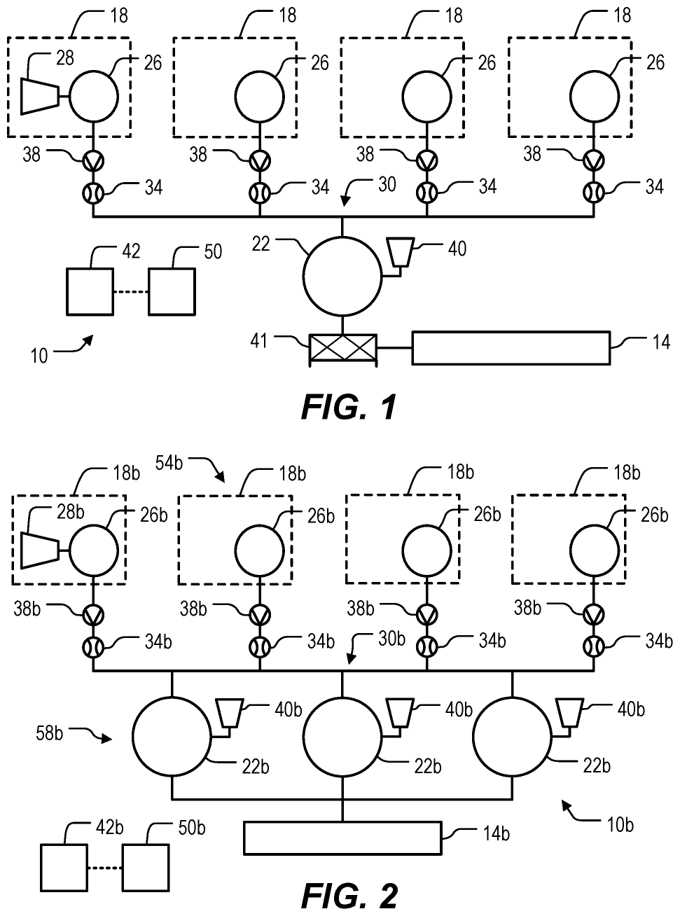

FIG. 1 is a schematic illustrating an ingredient preparation and batching system 10 according to one embodiment of the present disclosure. The ingredient preparation and batching system 10 allows the batching process to keep pace with a high speed bottling line 14. In particular, the ingredient preparation and batching system 10 includes a plurality of major ingredient pre-mix stations 18 fluidly coupled to at least one batch tank 22. The number of major ingredient pre-mix stations 18 is dependent upon the number of major ingredients that are common to the recipes being bottled. In the present embodiment, the system 10 of FIG. 1 includes four major ingredient pre-mix stations 18. The embodiment of FIG. 1, however, is provided as an example and it should be understood that fewer (e.g., three, two, or even one pre-mix station) or more than four pre-mix stations are also contemplated. Each major ingredient pre-mix station 18 is fluidly coupled to the batch tank 22. The batch tank 22 is fluidly coupled to the bottling line 14 to distribute the batch into individual bottles.

With continued reference to FIG. 1, each major ingredient pre-mix station 18 includes a holding tank 26. In some embodiments, the pre-mix stations 18 further include a mixer 28 operable to mix (or, dissolve) the major ingredient into water to produce a hydrated major ingredient. The holding tank 26 stores a relatively large quantity (e.g., a quantity sufficient for more than one batch) of a major ingredient in a hydrated state. In other words, each holding tank 26 holds a single major ingredient in a fluid form at a designated concentration. The use of individual holding tanks 26 allows each major ingredient to be traced and tested for quality and safety and allows for individual control over each ingredient in a recipe.

An arrangement of pipes 30 couples each holding tank 26 to the batch tank 22. The system 10 also includes one or more flow meters 34 (e.g., mass flow meters) are disposed at one or more locations within the arrangement of pipes 30 and adapted to detect a flow rate within the pipes 30. Each holding tank 26 is further coupled to at least one pump 38 via the arrangement of pipes 30 to convey the hydrated major ingredient from the holding tank 26 to the batch tank 22. The flow meters 34 measure the quantity of hydrated major ingredient fluid that is transferred from the holding tank 26 to the batch tank 22 so that the system 10 can ensure proper adherence to the recipe.

In the illustrated embodiment, the system 10 also includes a hopper 40 fluidly coupled to the batch tank 22. The hopper 40 can receive one or more minor ingredients and dispense predetermined quantities of the one or more minor ingredients contained therein into the batch tank 22 for mixing into the batch according to the recipe. In other embodiments, the hopper 40 can be uncoupled from the batch tank 22, and the minor ingredients contained therein can be manually measured and added into the batch tank 22 during the batching process.

With continued reference to FIG. 1, the system 10 further includes a heat treatment apparatus 41 fluidly coupled to the batch tank 22. The system 10 conveys a prepared batch from the batch tank 22 to the heat treatment apparatus 41 prior to bottling at the bottling line 14. The heat treatment apparatus 41 heat treats the prepared batch (e.g., via a pasteurization process, an ultra-high temperature (UHT) treatment process, or the like).

The system 10 also includes a user interface 42 operable to receive user input and display information relating to control of the system 10. Via the user interface 42, the user may input, retrieve, or modify at least one recipe for at least one consumable liquid product. The user interface 42 is operable to communicate the recipe to a controller 50 that is electrically coupled to the user interface 42, the pumps 38, and the flow meters 34. The controller 50 is operable to convey, via the pumps 38, a predetermined quantity of each major ingredient (i.e., based on the recipe) into the batch tank 22. The controller 50 is further operable to monitor the flow meters 34 during the pumping process to ensure an accurate amount of each major ingredient is supplied to the batch tank 22. The controller 50 is also electrically coupled to the hopper 40 and operable to dispense, via the hopper 40, a predetermined quantity of minor ingredients into the batch tank 22 according to the recipe.

To create a new batch for bottling, the operator first selects the desired recipe via the user interface 42 and initiates a batching process. The controller 50 then actuates the pumps 38 and flow meters 34 to convey predetermined quantities of each hydrated major ingredient from the holding tanks 26 to the batch tank 22. In the illustrated embodiment, the controller 50 also actuates the hopper 40 to dispense predetermined quantities of the minor ingredients into the batch tank 22. In other embodiments where the hopper 40 is uncoupled from the batch tank 22, the operator manually adds the minor ingredients to the batch tank 22. The hydrated major ingredients and the minor ingredients are mixed in the batch tank 22 (e.g., via jet mixing) to create a batch. The operator may then test the batch for quality and accuracy as compared to the recipe. At this point, a new batch has been created and is ready for bottling. The process of creating a new batch with the ingredient preparation and batching system 10 described above is more efficient and requires less operator input than the traditional manual batching process. The above-described system 10 requires between 30 and 60 minutes to complete the mixing of a new batch. More particularly, the system can create a new batch in about 40 minutes and is 30%-40% more efficient than a manual batching process. The ingredient preparation and batching system 10 is capable of creating a new batch in less time than the bottling line 14 depletes the entire previous batch.

The increased efficiency of this system is realized (at least in part) by decoupling the preparation of the major ingredients from the end stage mixing of the overall batch. By utilizing pre-mix stations 18 with holding tanks 26 that are separated from the batch tank 22, to the system 10 is able to continuously prepare the major ingredients independently of one another and of the final batch preparation process. When the batch tank 22 is ready to receive the ingredients for a batch, the system 10 conveys predetermined quantities of each hydrated major ingredient from the dedicated holding tanks 26 quickly (via the pumps 38) on demand (i.e., with no delay for major ingredient preparation). The system 10 does not require an operator to individually weigh and mix each ingredient at the time of batching.

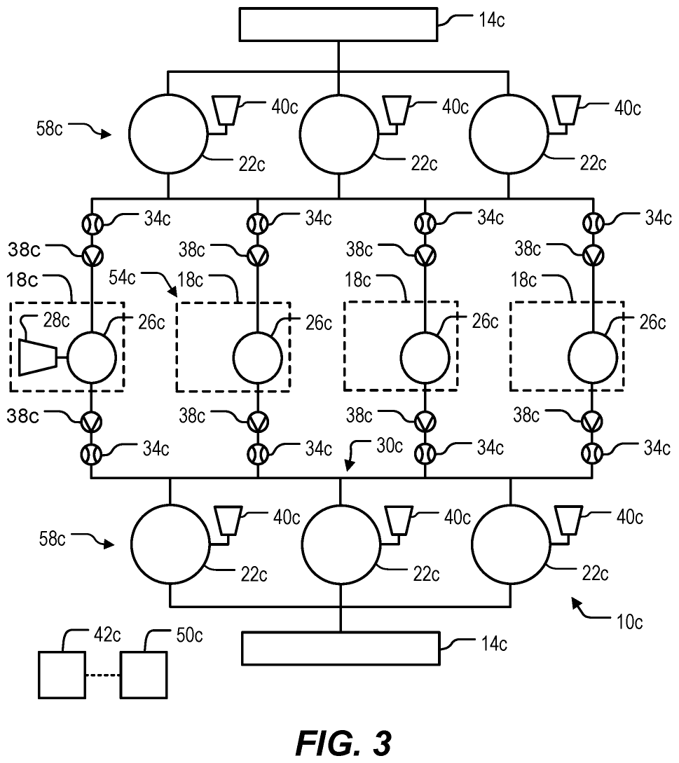

The ingredient preparation and batching system 10 as described above is scalable based on the number of major ingredients shared by recipes, the number of batch tanks 22 needed for each recipe, and the number of bottling lines 14 available. FIGS. 2 and 3 are schematics illustrating further embodiments of the ingredient preparation and batching system, with like features having like reference numerals plus the letters “b” and “c” respectively and having the following differences. FIG. 2 illustrates an ingredient preparation and batching system 10b in which one holding tank set 54b, having four holding tanks 26b, is fluidly coupled to a batch tank set 58b having a plurality of batch tanks 22b. Each batch tank 22b is fluidly coupled to the same bottling line 14b. The plurality of batch tanks 22b are adapted to hold batches of the same or different recipes. When the batch tanks 22b hold batches of the same recipe, the bottling line 14b can quickly shift to another batch tank 22b when the batch in one batch tank 22b is depleted.

FIG. 3 illustrates an ingredient preparation and batching system 10c in which one holding tank set 54c, having four holding tanks 26c, is fluidly coupled to two batch tank sets 58c. Each batch tank set 58c includes three batch tanks 22c, and each batch tank set 58c is fluidly coupled to a different respective bottling line 14c. Each batch tank set 58c holds batches of a different recipe, while each batch tank 22c within a batch tank set 58c holds a batch of the same recipe. Therefore, the ingredient preparation and batching system 10c is capable of creating batches of various recipes and providing the batches to two distinct bottling lines 14c.

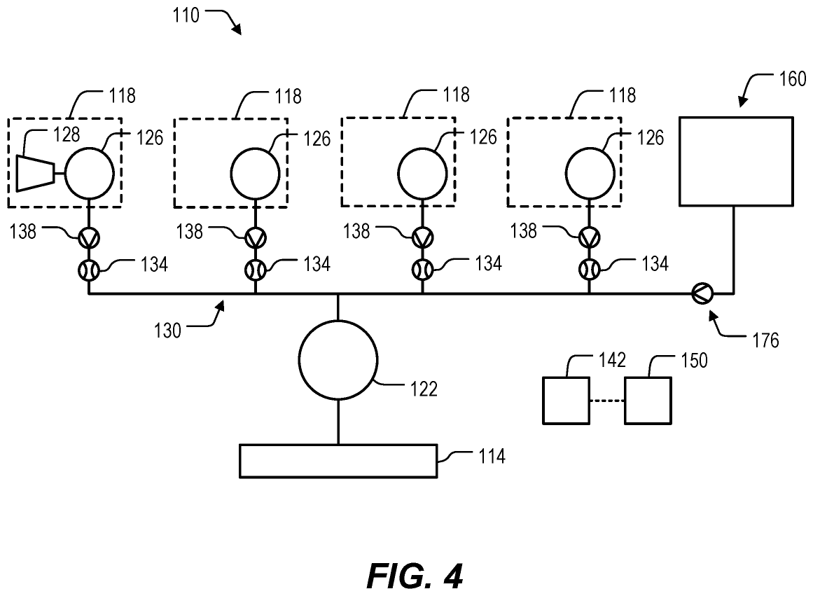

FIGS. 4-6C illustrate ingredient preparation and batching systems that are operable to prepare and bottle low-acid beverages (e.g., protein drinks). The beverages are dispensed into individual bottles by a bottling line which pulls prepared batches of the beverages from a batch tank to fill the bottles. Prior to the filling process, a batching process is implemented to combine ingredients based on a supplied recipe of the beverage. The pre-mixed ingredients (i.e., the batch) can be stored in the batch tank and/or in one or more aseptic tanks until they are bottled. The batching process may involve at least one operator manually combining multiple ingredients according to the recipe. The ingredients can be manually weighed and mixed into the batch to allow for testing and to ensure the quality and safety of the end product.

In some instances, the bottling lines used to bottle the batch of ingredients can utilize an aseptic line which operates at a high rate of speed. For example, the bottling line may be capable of filling around 66,000 bottles per hour. When such a high speed bottling line is used, it is possible for the bottling line to deplete the batch of pre-mixed ingredients before the operators can prepare a new batch. The ingredient preparation and batching systems should be capable of preparing large batches of low-acid beverages (e.g., 20,000 gallons of beverage or more in a single batch) to improve efficiency and meet demand. Furthermore, the preparation of low-acid beverages is subject to time constraints based on food safety requirements. Much of the time required to prepare the new batch is spent measuring (e.g., weighing) the ingredients to be included. The present disclosure improves the batching process by storing ingredients in bulk, pre-mixing ingredients in bulk, and supplying the ingredients quickly and accurately to the batch tank.

Recipes for low-acid liquid products to be bottled typically include non-time constrained ingredients and time constrained ingredients. For the purpose of this disclosure, non-time constrained ingredients should be understood as ingredients which may be hydrated and stored within a critical temperature range (e.g., from about 40 degrees Fahrenheit to about 140 degrees Fahrenheit) for relatively longer periods of time prior to being mixed into a batch and bottled without failing food safety regulations. For example, non-time constrained ingredients may be hydrated and stored within the critical temperature range for 4 hours or more without failing food safety regulations and without spoiling. Examples of non-time constrained ingredients include, e.g., cocoa, phosphate, ascorbic acid, etc. In contrast, time constrained ingredients should be understood as ingredients which should only be hydrated and held within the critical temperature range immediately prior to creating a batch and bottling to ensure that food safety regulations are met. For example, time constrained ingredients should be hydrated and stored within the critical temperature range for no longer than 4 hours according to food safety regulations. In other words, time constrained ingredients are subject to food safety regulations dictating the amount of time they may be in a hydrated state prior to bottling during an aseptic process. Examples of time constrained ingredients can include, e.g., protein-based ingredients (e.g., milk protein, whey protein, etc.). For example, some food safety regulations may require that a low-acid beverage (e.g., a protein drink) should be prepared and bottled by an aseptic process in under 4 hours, starting from the moment the first time constrained ingredient is hydrated and ending at the moment the beverage is bottled. Such regulations will permit the bottled low-acid beverage to be designated as ‘shelf stable’ and stored unrefrigerated for extended periods if these conditions are met. The present disclosure provides a system for decoupling the preparation of non-time constrained ingredients and time constrained ingredients to more quickly and efficiently prepare and bottle a batch.

FIG. 4 is a schematic illustrating an ingredient preparation and batching system 110 according to one embodiment of the present disclosure. The ingredient preparation and batching system 110 allows the batching process to keep pace with a high speed bottling line 114. In particular, the ingredient preparation and batching system 110 includes a plurality of hydrated ingredient pre-mix stations 118 fluidly coupled to at least one batch tank 122. The number of hydrated ingredient pre-mix stations 118 is dependent upon the number of non-time constrained ingredients that are common to the recipes being bottled. In the present embodiment, the system 110 of FIG. 4 includes four hydrated ingredient pre-mix stations 118. The embodiment of FIG. 4, however, is provided as an example and it should be understood that fewer than four hydrated ingredient pre-mix stations (e.g., three, two, or even one station) or more than four hydrated ingredient pre-mix stations are also contemplated. Each hydrated ingredient pre-mix station 118 is fluidly coupled to the batch tank 122. The batch tank 122 is fluidly coupled to the bottling line 114 to distribute the batch into individual bottles.

With continued reference to FIG. 4, each hydrated ingredient pre-mix station 118 includes a holding tank 126. In some embodiments, the hydrated ingredient pre-mix stations 118 further include a mixer 128 operable to mix (or, dissolve) the major ingredient into water to produce a hydrated major ingredient. The holding tank 126 stores a relatively large quantity (e.g., a quantity sufficient for more than one batch) of a non-time constrained ingredient in a hydrated state. In other words, each holding tank 126 holds a single hydrated ingredient prepared from one or more non-time constrained ingredients and provided in a liquid form at a designated concentration. The use of individual holding tanks 126 allows each hydrated ingredient to be traced and tested for quality and safety and allows for individual control over each ingredient in a recipe.

An arrangement of pipes 130 couples each holding tank 126 to the batch tank 122. The system 10 also includes one or more flow meters 134 (e.g., mass flow meters) disposed at one or more locations within the arrangement of pipes 130 and adapted to detect a flow rate within the pipes 130. Each holding tank 126 is further coupled to at least one pump 138 via the arrangement of pipes 30 to convey the hydrated ingredient from the holding tank 126 to the batch tank 122. The flow meters 134 measure a quantity of hydrated major ingredient (e.g., in liquid form) that is transferred from the holding tank 126 to the batch tank 122 so that the system 110 can ensure proper adherence to the recipe.

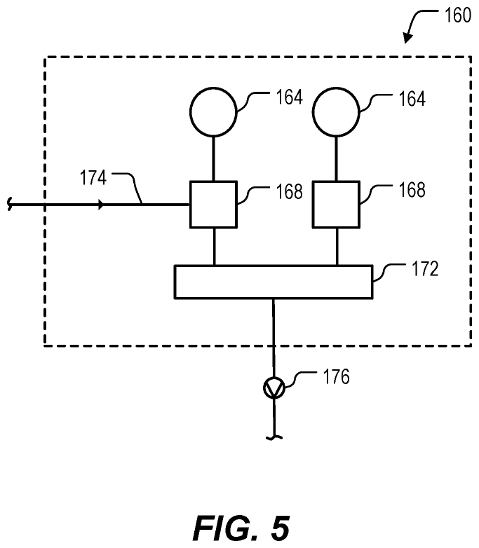

With reference to FIGS. 4 and 5, the system 110 further includes at least one dry ingredient pre-mix station 160 for mixing two or more time constrained ingredients (e.g., non-hydrated or dry time constrained ingredients). The dry ingredient pre-mix station 160 includes at least one unloader 164, at least one hopper 168 operably coupled to the unloader 164, and a mixer 172 operably coupled to the hopper(s) 168 and to the batch tank 122. In the present embodiment, the system 110 includes two unloaders 164 and two hoppers 168. The embodiment of FIG. 5, however, is provided as an example and it should be understood that fewer (e.g., one unloader 164 and/or one hopper 168) or more than two unloaders 164 and hoppers 168 are also contemplated. It should further be understood that the number of unloaders 164 and hoppers 168 need not be equal.

With continued reference to FIG. 5, each unloader 164 is adapted to receive a package (not shown; e.g., a 50 pound bag or a supersack) containing a time constrained ingredient in a dry or powdered form and unload the time constrained ingredient from the package. In the illustrated embodiment, each unloader 164 receives a package containing a time constrained ingredient in a powder form. Each hopper 168 stores the time constrained ingredient after it has been removed from the package by the respective unloader 64 to which the hopper 168 is coupled. In some examples, each hopper 168 may store a different time constrained ingredient (e.g., milk protein and whey protein). In other examples, two or more hoppers 168 can store the same time constrained ingredient. In further examples, one hopper 168 can store a time constrained ingredient (e.g., a protein-based ingredient) and another hopper 168 can store a non-time constrained ingredient (e.g., phosphate).

The mixer 172 is operably coupled to each of the hoppers 168 to receive the time constrained ingredients stored in the hoppers 168. The mixer 172 may include or utilize one or more vacuum sources (e.g., vacuum pumps; not shown) operable to create a vacuum that draws one or more of the time constrained ingredients from the hoppers 168 to the mixer 172 individually and in predetermined quantities according to the batch recipe. In the same or other embodiments, the system 110 may include a compressor (not shown) within or separate from the mixer 172 which may be operable to move the time constrained ingredients from the hoppers 168 to the mixer 172 by compressed air.

The mixer 172 then mixes two or more time constrained ingredients to form a single time constrained ingredient mix. In the illustrated embodiment, the system 110 further includes a water supply line 174 that supplies water to the mixer 171. For example, the water supply line 174 may supply reverse osmosis (R/O) water that may be at ambient temperature or heated above ambient temperature. The mixer 172 may also hydrate the time constrained ingredient mix using the water supplied from the water supply line 174.

In other embodiments of the system 110, the time constrained ingredient mix may not be hydrated at the mixer 172, but instead may be prepared in the mixer 172 in powder form. In such embodiments, the non-hydrated time constrained ingredient mix is transported to the batch tank 122 (e.g., by vacuum or compressed air) prior to hydrating, and may be hydrated at the batch tank 122.

The system 110 further includes a transfer mechanism 176 that operably couples the mixer 172 to the batch tank 122 (FIG. 4). In the illustrated embodiment, the transfer mechanism 176 is a liquid pump that moves the hydrated time constrained ingredient mix from the mixer 172 to the batch tank 122. The transfer mechanism 176 may also include a metering mechanism (not shown) operable to measure the quantity of the hydrated time constrained ingredient mix that moves from the mixer 172 to the batch tank 122.

The time constrained dry ingredient mix (whether hydrated at the mixer 172 or non-hydrated) enters the batch tank 122 where it mixes with the hydrated ingredients coming from the pre-mix stations 118 to form a batch of the low-acid beverage.

The hoppers 168 can be sufficiently large to hold and store the contents of many packages (e.g., such as 50 pound bags or supersacks) of the time constrained ingredients. For example, the hoppers 168 can have a hold capacity of 10 cubic meters (m³) or more. Because the time constrained ingredients are stored in the hoppers 168 in dry powder form, the previously mentioned time constraints related to food safety regulations and preventing spoiling do not apply to the time constrained ingredients while they are stored in the hoppers 168. This allows the process of unloading the packages via the unloaders 164 to transpire independently of the product batching process. Moreover, the time constrained ingredients can be stored in the hoppers 168 in quantities in excess of the required quantity of a single batch of the product. Therefore, large quantities of the time constrained ingredients can quickly be conveyed on-demand from the hoppers 168 to the mixer 172 (e.g., via the vacuum source described herein).

With reference to FIGS. 4 and 5, the system 110 also includes a user interface 142 for operator control of the system 110. The user interface 142 includes at least one recipe to be selected by an operator. The user interface 142 is operable to communicate the recipe selection to a controller 150 that is electrically coupled to the user interface 142, the pumps 138, the flow meters 134, and the transfer mechanism 176. The controller 150 is operable to transfer the required amount of each hydrated ingredient and the time constrained ingredient mix (i.e., according to the recipe) into the batch tank 122. The controller 150 is further operable to monitor the flow meters 134 and the transfer mechanism 176 during the pumping process to ensure an accurate amount of each hydrated ingredient and of the time constrained ingredient mix is supplied to the batch tank 122.

To create a new batch for bottling, the operator first selects the desired recipe via the user interface 142 and initiates a batching process. The controller 150 then actuates the pumps 138 to convey predetermined quantities of each hydrated ingredient from the holding tanks 26 to the batch tank 122. The controller also controls the mixer 172 and the hoppers 168 to draw one or more of the time constrained ingredients from the hoppers 168 into the mixer 172. The time constrained ingredients are supplied from the hoppers 168 to the mixer 172 individually and in predetermined quantities according to the recipe in order to form a time constrained ingredient mix. The controller 150 further controls the mixing and hydration of the time constrained ingredient mix, including, in some embodiments, the supply of R/O water from the water supply line 174 for hydrating the time constrained ingredient mix. The controller 150 also actuates the transfer mechanism 176 to transfer a predetermined quantity of the time constrained ingredient mix to the batch tank 122. Actuation of the pumps 138 and the transfer mechanism 176 may happen simultaneously or in sequence. The operator then tests the batch for accuracy. At this point, a new batch has been created and is ready for bottling at the bottling line 114.

In the illustrated embodiment, the time constrained ingredient mix is hydrated prior to reaching the batch tank 122. As discussed herein, in other embodiments, the time constrained ingredient mix can instead remain dry (i.e., non-hydrated or having no water added) until reaching the batch tank 122. In these embodiments, the controller 150 is operable to actuate the transfer mechanism 176 in order to transfer a predetermined amount of the non-hydrated time constrained ingredient mix to the batch tank 122.

By decoupling the preparation of the non-time constrained ingredients and the time constrained ingredients, the system 110 improves the speed and efficiency of low-acid bottling processes as compared to past bottling systems. By utilizing separate holding tanks 126, operators are able to continuously and efficiently prepare the hydrated ingredients independently of one another and of the final batch preparation. Furthermore, storing the time constrained ingredients in the hoppers 168 and creating the time constrained ingredient mix in the mixer 172 delays the hydration of the time constrained ingredients, thus allowing larger batches to be created and bottled in shorter periods of time (e.g., 4 hours or less) to meet food safety regulations.

The ingredient preparation and batching system 110 as described above is scalable based on the number of non-time constrained ingredients shared by recipes, the number of time constrained ingredients shared by recipes, the number of batch tanks 122 needed for each recipe, and the number of bottling lines 114 available.

Although the ingredient preparation and batching system 110 has been described herein in connection with preparing low-acid beverages, the system 110 is also capable of preparing high acid beverages (e.g., juices, carbonated soft drinks, etc.). In instances of high acid beverage preparation, the dry ingredient pre-mix station 160 can be utilized to unload, store, and mix non-time constrained ingredients, and convey the resultant ingredient mix from the mixer 172 to the batch tank 122 in a manner similar to that already described herein. Under such circumstances, the dry ingredient pre-mix station 160 still increases the speed and capacity of the batching system 110 by automatically unloading the packages via the unloaders 164, storing the non-time constrained ingredients in dry powder form in quantities in excess of those required by the batch recipe, and supplying large quantities of the non-time constrained ingredients to the mixer 172 on demand.

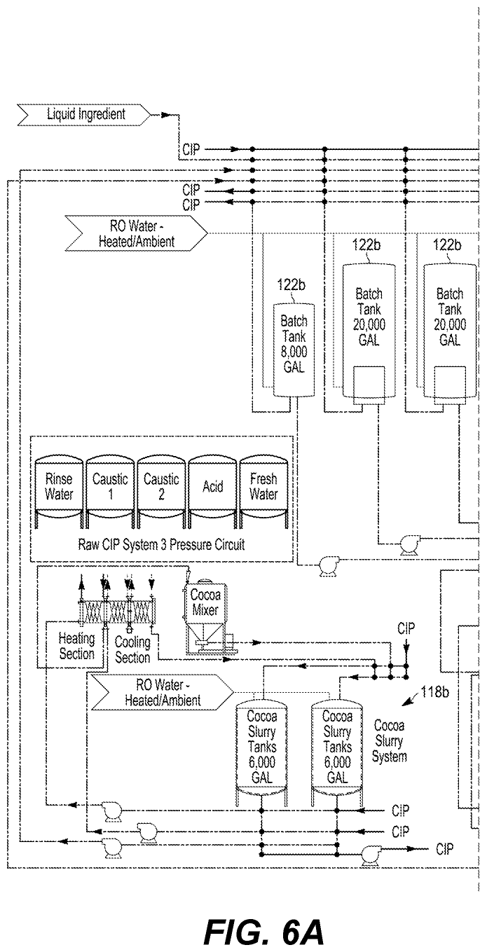

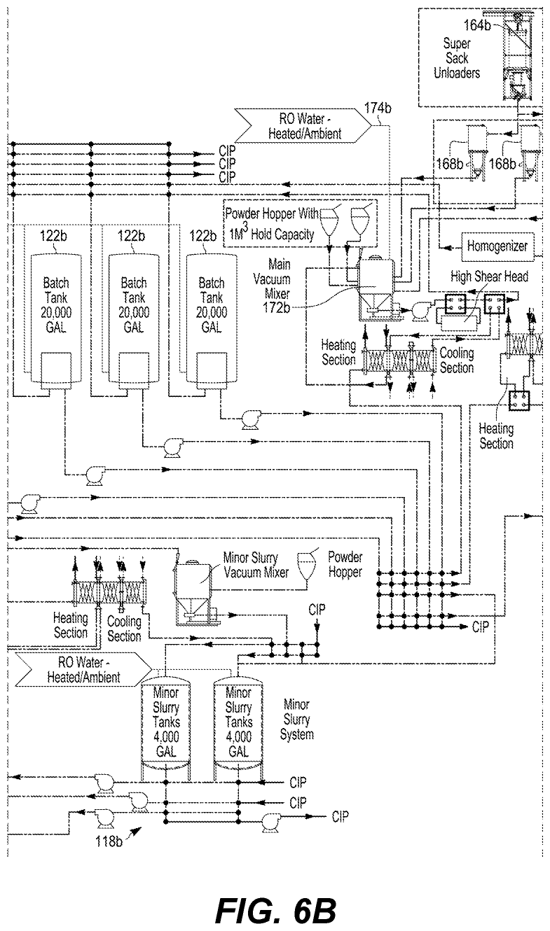

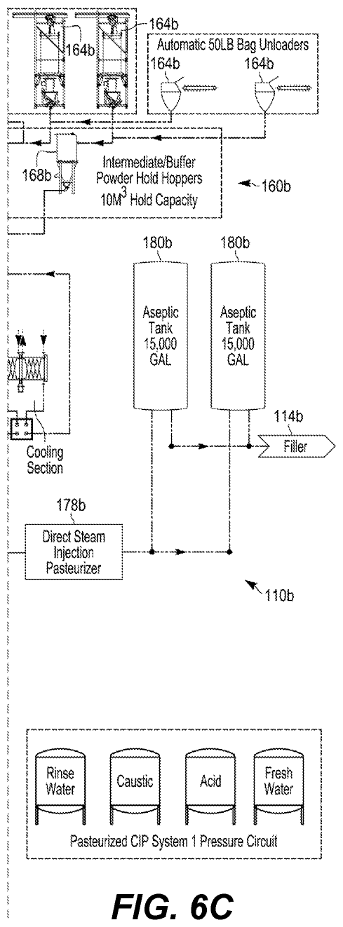

FIGS. 6A-6C schematically illustrate another embodiment of the ingredient preparation and batching system, with like features having like reference numerals plus the letters “b”, and the following differences explained below. The ingredient preparation and batching system 110b of FIGS. 6A-6C include two hydrated ingredient pre-mix stations 118b operably coupled to six batch tanks 122b. The system 10b also includes five unloaders 164b operably coupled to three hoppers 168b, which in turn are operably couped to a single mixer 172b. The mixer 172b is operably coupled to a water supply line 174b and to each of the six batch tanks 122b. Each batch tank 122b is fluidly coupled to the same bottling line 114b. The plurality of batch tanks 122b are adapted to hold batches of the same or different recipes. When the batch tanks 122b hold batches of the same recipe, the bottling line 114b can quickly shift between batch tanks 122b when the batch in one batch tank 122b is depleted.

As shown in FIG. 6, the system 110b further includes a pasteurization station 178b downstream from the batch tanks 122b and upstream of the bottling line 114b. The pasteurization station 178b is operable to pasteurize the low-acid beverage (e.g., by direct steam injection) just prior to bottling. The system 110b further includes one or more aseptic tanks 180b (e.g., two 15,000 gallon aseptic tanks 180b are shown) for storing the pasteurized batch of the low-acid beverage immediately prior to bottling. The system 110b is capable of preparing and bottling batches of 20,000 gallons or more of the low-acid beverage within 4 hours or less.

Various features of the disclosure are set forth in the following claims.

What is claimed is:

1. An ingredient preparation and batching system for use with a bottling line, the ingredient preparation and batching system comprising:
a first hydrated ingredient pre-mix station including a first holding tank configured to store a first hydrated ingredient consisting of water and one or more non-time constrained ingredients;
a dry ingredient pre-mix station including
a first hopper configured to store a first ingredient in dry form,
a second hopper configured to store a second ingredient in dry form, and
a mixer fluidly coupled to the first hopper and the second hopper, the mixer configured to receive and mix the first ingredient and the second ingredient to form an ingredient mix;
a batch tank fluidly coupled to the first holding tank and the mixer, the batch tank configured to
receive a predetermined quantity of the first hydrated ingredient from the first holding tank,
receive a predetermined quantity of the ingredient mix from the mixer, and
store a batch of a liquid product comprising the first hydrated ingredient and the ingredient mix;
wherein the first ingredient is a time constrained ingredient.

2. The ingredient preparation and batching system of claim 1, further comprising a second hydrated ingredient pre-mix station including a second holding tank configured to store a second hydrated ingredient different from the first hydrated ingredient, wherein the batch tank is further configured to receive a predetermined quantity of the second hydrated ingredient from the second holding tank.

3. The ingredient preparation and batching system of claim 1, wherein the dry ingredient pre-mix station further includes a first unloader operably coupled to the first hopper and configured to receive a package containing the first ingredient and unload the first ingredient from the package into the first hopper.

4. The ingredient preparation and batching system of claim 1, further comprising one of: a) a vacuum source configured to convey the first ingredient from the first hopper to the mixer, or b) a compressed air source configured to convey the first ingredient from the first hopper to the mixer.

5. The ingredient preparation and batching system of claim 1, further comprising a transfer mechanism configured to convey the predetermined quantity of the ingredient mix from the mixer to the batch tank.

6. The ingredient preparation and batching system of claim 5, further comprising an electronic controller configured to operate the transfer mechanism to convey the predetermined quantity of the ingredient mix from the mixer to the batch tank.

7. The ingredient preparation and batching system of claim 6, further comprising a user interface in electrical communication with the electronic controller and configured to communicate a recipe of the liquid product to the electronic controller.

8. A dry ingredient pre-mix station for use with an ingredient preparation and batching system operable to supply a batch of a liquid product from a batch tank to a bottling line, the dry ingredient pre-mix station comprising:
a first hopper configured to store a first ingredient in dry form;
a first unloader operably coupled to the first hopper and configured to receive a first package containing the first ingredient and unload the first time constrained ingredient from the first package into the hopper;
a second hopper configured to store a second ingredient in dry form; and
a mixer fluidly coupled to the first hopper and the second hopper, the mixer configured to receive and mix the first ingredient and the second ingredient to form an ingredient mix;
wherein the first ingredient is a time constrained ingredient.

9. The dry ingredient pre-mix station of claim 8, further comprising a second unloader operably coupled to the second hopper and configured to receive a second package containing the second time constrained ingredient and unload the second time constrained ingredient from the second package.

10. The dry ingredient pre-mix station of claim 8, further comprising one of: a) a vacuum source configured to convey the first ingredient from the first hopper to the mixer, or b) a compressed air source configured to convey the first ingredient from the first hopper to the mixer.

11. The dry ingredient pre-mix station of claim 8, further comprising a transfer mechanism configured to convey a predetermined quantity of the ingredient mix from the mixer to the batch tank.

12. The dry ingredient pre-mix station of claim 8, wherein the mixer is further configured to receive water from a water supply line and hydrate the ingredient mix.

13. A method of preparing a batch of a liquid product for a bottling line, the method comprising:
conveying a first ingredient in dry form from a first hopper to a mixer;
conveying a second ingredient in dry form from a second hopper to a mixer;
mixing the first ingredient and the second ingredient to form an ingredient mix;
conveying the ingredient mix from the mixer to a batch tank; and
combining the ingredient mix with a hydrated ingredient within the batch tank to produce a batch;
wherein the first ingredient is a time constrained ingredient.

14. The method of claim 13, wherein the second ingredient is a time constrained ingredient.

15. The method of claim 13, wherein the first ingredient is conveyed from the first hopper to the mixer via one of: a) a compressed air source; and b) a vacuum source.

16. The method of claim 13, wherein mixing the first ingredient and the second ingredient to form the ingredient mix further comprises hydrating the first ingredient and the second ingredient with water.

17. The method of claim 13, wherein the hydrated ingredient is a first hydrated ingredient, and wherein the method further comprises combining a second hydrated ingredient with the ingredient mix and the first hydrated ingredient within the batch tank to produce the batch.

18. The method of claim 13, wherein the hydrated ingredient consists of water and one or more non-time constrained ingredients.

19. The method of claim 13, further comprising:
pasteurizing the batch; and
storing the batch in an aseptic tank.

20. The method of claim 19, further comprising:
unloading, via an automated unloader, the first ingredient from a package containing the first ingredient; and
conveying the first ingredient from the automated unloader to the first hopper.
